(19) United States
(12) Patent Application Publication
(10) Pub. No.: US 2003/0004786 A1
(43) Pub. Date: Jan. 2, 2003

(54) Method for performing multilingual market presearch through a two-way computer communication network and a communication system and information recording medium for the same method

(76) Inventors: Hidemasa Tokieda, Zama-shi (JP); Tadao Mikami, Chiba-shi (JP); Koji Mori, Tokyo (JP)

Correspondence Address: Kanesaka & Takeuchi, 1423 Powhatan Street, Alexandria, VA, 22314, US

(21) Appl. No.: 10/149,226

(22) PCT Filed: Jul. 4, 2001
(86) PCT No.: PCT/JP01/05803

(30) Foreign Application Priority Data
Oct. 16, 2000 (JP) 2000-315784

(51) Int. Cl. G06F 17/60

(52) U.S. Cl. 705/10

(57) ABSTRACT

The invention provides a system for making it possible to quickly and securely perform particularly an international market research in many languages through a two-way computer communication network.

In a two-way computer communication network (an extranet or the Internet) using a digital wire communication network 1, a multilingual market research Web site apparatus 2 receives a request for a multilingual market research, performs invitation of answerers to the multilingual market research, asks the answerers who have applied for the invitation to answer to the multilingual market research, and performs a report based on answer information to the market research from answerers. A multilingual user apparatus 3 responds to the invitation of answerers to the multilingual market research from the multilingual market research Web site apparatus 2, and transfers information related to the requested market research. And a multilingual market research requester apparatus 4 requests a multilingual market research and receives a report of the market research from the multilingual market research Web site apparatus 2.

### TECHNICAL FIELD

The present invention relates to a method for performing a multilingual market research through a two-way computer communication network, performing for example an international market research in many languages utilizing a two-way computer communication network, and a communication system and information recording medium for the same method.

### BACKGROUND ART

Up to now, an example of utilizing a communication network (intranet, Internet and extranet) under a TCP/IP (Transmission Control Protocol/Internet Protocol) environment is known as a market research (properly, written as a “market research” or abbreviated as MR) through a two-way computer communication network of this kind. For example, there is publicly known such a market research that an administrator of a banner advertisement with a quiz offering a prize collects the address, name, electronic mail address and the like inputted by a reader of the banner advertisement into a home page and utilizes such information (personal attribute information) as answers to the quiz and the like. Such a market research is domestically performed in general. In other words, such a market research is performed in one language.

Recent commercial distribution to be the subject of a market research is expanded either inside or outside a country. That is to say, commodity purchase through mail order from foreign countries (for example, personal imports) and the like are active, and for an efficient sale or service offer, an international market research has been needed. In such an international market research, information of a market research performed in a country is often obtained in another country and translated and then utilized.

Therefore, an international market research has a problem that it takes a long time for acquisition and translation of information, makes it difficult to quickly obtain market information and hinders an effective market development. As such translation utilizing a two-way computer communication network (intranet, Internet and extranet), there is an example of building a Web site in each language of many languages and making each Web server perform a translation process of a language. This example brings the enlargement of processing scale and apparatus scale.

### DISCLOSURE OF THE INVENTION

In such a conventional example as described above, there is a problem that an international market research using many languages has not been established and, for example, a multinational corporation cannot easily develop onto the market.

The present invention attempts to solve such a problem of the prior art, and an object of the present invention is to provide a method for performing a multilingual market research through a two-way computer communication network,

said method making it possible to quickly and surely perform particularly an international market research in many languages by means of a two-way computer communication network and for example making it easy for a multinational corporation to develop onto the market, and a communication system and information recording medium for the same method.

In order to attain the above object, a method for performing a multilingual marketing research through a two-way computer communication network according to the present invention is characterized by comprising a step in which a market research performing side receives a request for a multilingual market research, a step in which the market research performing side invites answerers to the multilingual market research through said communication network, a step in which the market research performing side asks the answerers who have applied for the invitation to answer to the market research in many languages through said communication network, a step of translating answer information to the multilingual market research through a multilingual translation network, and a step in which the market research performing side performs a report based on answer information to the market research from the answerers to the market research requester side.

A method of the present invention is characterized in that said multilingual market research is an international market research related to areas where many languages are in use and/or users of many languages.

Further, a method of the present invention is characterized in that said market research performing side obtains attribute information related to answerers including their translatable languages, areas, names, addresses, sexes and ages from the answerers when inviting answerers to said multilingual market research, and selects contents of requested market research information, said contents being matched with the attribute information, and asks the answerers to answer to the market research.

And a method of the present invention is characterized in that an answerer performs translation through said multilingual translation network when the answerer answers to the market research. Further, a method of the present invention is characterized in that the market research performing side receives answer information to the market research from an answerer through a communication network and thereafter a translator other than the answerer performs translation through said multilingual translation network. And a method of the present invention is characterized in that said market research performing side and the market research requester side are the same as each other.

Further, a method of the present invention is characterized by settling a reward to said answerer and a charge for said market research through the communication network.

And a method of the present invention is characterized by settling said reward to an answerer by offering an article including a gift certificate.

Further, a method of the present invention is characterized in that the market research performing side judges whether or not said answer information to the market research from an answerer is adequate and, in case that the answer information is inadequate, asks a question of the answerer to compensate for the inadequacies. And a method of the present invention is characterized in that the market research performing side gives a password to each of answerers and the market research requester side and performs transmission/reception of information through the communication network by means of the passwords.

A multilingual market research communication system of the present invention characterized by comprising a multilingual market research Web site apparatus for receiving a request for a multilingual market research, performing invitation of answerers to the multilingual market research, asking an answerer who has applied for this invitation to answer to the multilingual market research and transferring a report based upon answer information to the market research from answerers to the market research requester side, a multilingual user apparatus for responding to the invitation of answerers to the multilingual market research from said multilingual market research Web site apparatus and transferring answer information to the requested market research, and a multilingual market research requester apparatus for requesting said multilingual market research Web site apparatus to perform a multilingual market research and receiving a report of the market research from said multilingual market research Web site apparatus.

A system of the present invention is characterized in that said communication network is a communication network under a TCP/IP environment. And a system of the present invention is characterized in that said communication network is a public or non-public wire communication network, and said multilingual market research Web site apparatus, multilingual user apparatus and multilingual market research requester apparatus each are a fixed computer.

Further, a system of the present invention is characterized in that said communication network is a public or non-public mobile communication network, and said multilingual market research Web site apparatus, multilingual user apparatus and multilingual market research requester apparatus each are of a composition having a mobile telephone connected to a mobile computer or are a mobile telephone having a mobile computer function built in it.

And a system of the present invention is characterized in that a net-bank apparatus for settling a reward to be paid by said multilingual market research Web site apparatus side to a multilingual user apparatus side in compensation for an answer to the market research and a charge for the market research to be received by the multilingual market research Web site apparatus side from the multilingual market research requester apparatus side is further arranged on the communication network.

Further, a system of the present invention is characterized in that said multilingual market research Web site apparatus is provided with a multilingual market research database for, on request, matching (tracking) market research contents stored in it with attribute information related to answerers including their translatable languages, areas, names, addresses, sexes and ages obtained when inviting the answerers to a multilingual market research.

And a system of the present invention is characterized in that said multilingual market research Web site apparatus and said multilingual market research requester apparatus are separately arranged on the communication network, and said multilingual market research Web site apparatus and said multilingual market research requester apparatus are operated by different operators, or said multilingual market research Web site apparatus and said multilingual market research requester apparatus are formed in one and said multilingual market research Web site apparatus is operated by an operator of said multilingual market research requester apparatus. Further, a system of the present invention is characterized in that said system composition functions as a multilingual translation network for performing multilingual translation using a communication network.

At information recording medium of the present invention is characterized by storing in it a program for enabling a substantial computer to control a process in which a market research performing side receives a request for a multilingual market research, a process in which the market research performing side performs invitation of answerers to the multilingual market research through said communication network, a process in which the market research performing side asks the answerers who have applied for the invitation to answer to the multilingual market research through said communication network, a process of translating answer information to the multilingual market research through a multilingual translation network, and a process in which the market research performing side performs a report based on answer information to the market research from answerers to the market research requester side.

An information recording medium of the present invention is characterized by storing in it a program for enabling a substantial computer to control one process or some combined processes or all of the following processes (a) to (g), namely, (a) a process of performing a request for a market research and a report of a market research through a communication network, (b) a process of selecting market research contents matched with attribute information obtained when inviting answerers to the multilingual market research and asking answerers to answer to the market research, (c) a process in which an answerer performs translation when answering to the market research, (d) a process in which the market research performing side receives answer information to the market research through a communication network and thereafter a translator other than the answerer translates the answer information through a multilingual translation network, (c) a process of settling a reward to an answerer and a charge for the market research through a net bank on the communication network, (f) a process of correcting and compensating for inadequate answer information to the market research from an answerer through a communication network, and (g) a process of transmitting/receiving information through a communication network by means of passwords.

Such a method for performing a multilingual market research through a two-way computer communication network of the present invention, and a communication system and information recording medium for the same method ask the invited answerers to a market research in many languages to answer to the multilingual market research on a two-way computer communication, for example, an extranet (the Internet), and then obtain answers corresponding to each of areas where the many languages are in use or users of the many language.

As a result, it becomes possible to quickly and securely perform particularly an international market research in many languages through a two-way computer communication network. For example, it is becomes possible to quickly and securely perform an international market by a request from a multinational corporation and to enable the multinational corporation to easily develop onto the market.

### BRIEF DESCRIPTION OF THE DRAWINGS

FIG. 1 is a block diagram showing the total configuration of an embodiment of the present invention.

FIG. 2 is a block diagram showing a composition example of a main part of a Web server in the embodiment.

FIG. 3 is a diagram for explaining multilingual translation in the embodiment.

FIG. 4 is a block diagram for explaining a functional composition for performing a translation process of FIG. 3.

FIG. 5 is a flowchart showing a processing procedure of multilingual translation utilizing a multilingual translation network in the embodiment.

FIG. 6 is a flowchart showing a maintenance procedure in many languages by the functional composition shown in FIG. 5.

FIG. 7 is a block diagram showing processes in a multilingual market research database in the embodiment.

FIG. 8 is a rough sequence diagram in performance of a multilingual market research of the present invention.

FIG. 9 is a flowchart showing a processing procedure related to invitation of answerers to a multilingual market research in the embodiment.

FIG. 10 shows a display screen of invitation of answerers to a multilingual market research in the embodiment.

FIG. 11 shows an input screen of application to invitation of answerers to a multilingual market research in the embodiment.

FIG. 12 is a processing procedure of performance of a multilingual market research in the embodiment.

FIG. 13 shows a display screen of a market research site in many languages in the embodiment.

FIG. 14 shows another display screen of a market research site in many languages in the embodiment.

FIG. 15 is a block diagram showing the composition of a main part of a mobile communication network in the embodiment.

### BEST MODE FOR CARRYING OUT THE INVENTION

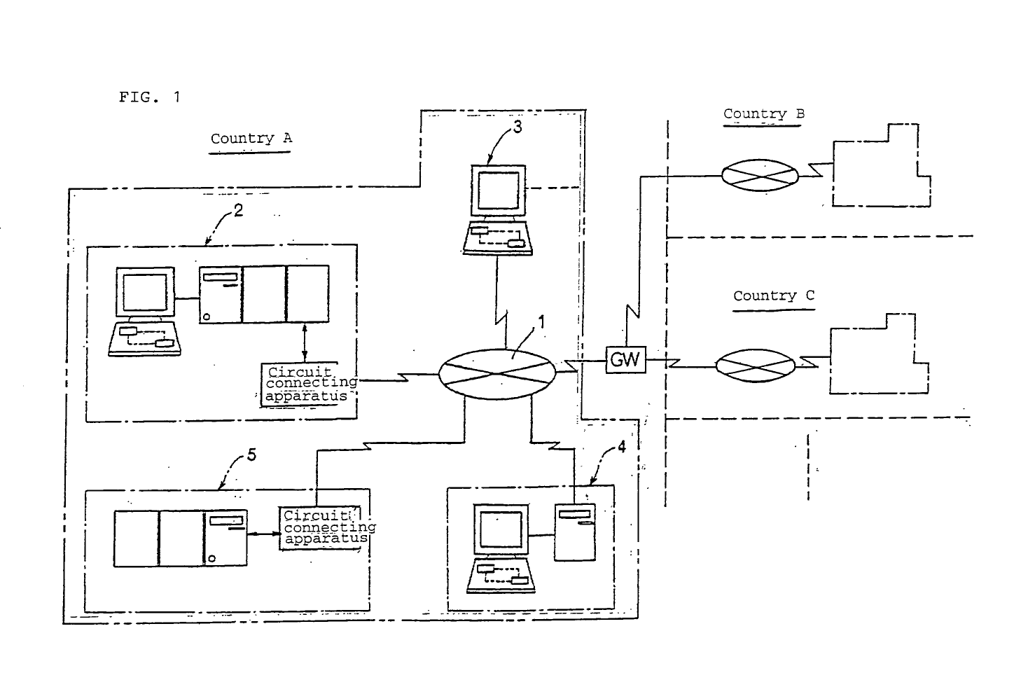

Next, embodiments of a method for performing a multilingual market research through a two-way computer communication network, and a communication system and information recording medium for the same method are described in detail with reference to the drawings. FIG. 1 is a block diagram showing the structure of an embodiment of the present invention.

In FIG. 1, this example is a two-way computer communication network under a TCP/IP environment, and shows a rough composition example of an extranet in which the Internet of each country (including areas also) of plural countries is connected to the Internet of another country. In this example extranet,

for example, a multilingual market research (MR) Web site apparatus 2 for performing a multilingual market research and a plurality of multilingual user apparatuses 3 for performing a multilingual translation and market research are connected to a digital wire communication network 1 (ISDN: Integrated Services Digital Network) as the Internet built in Japan (country A).

A market research in many languages in this case means a market research to an area where a specific language in many languages is in use or to users of this specific language. Therefore, answers to a market research are not necessarily written in the said language. Translation of answers to the market research is translation into a language required by a requester side. Further,

a report to the requester side also results in being a report written in a language specified by the requester side instead of a report written in a language of the area where the market research has been performed.

Further, a plurality of multilingual market research (MR) requester apparatuses 4 for requesting a multilingual market research of the multilingual market research Web site apparatus 2 side and a net-black apparatus 5 for performing a net settlement (electronic commercial transaction) of a charge for a market research in many languages are connected to a digital wire communication network 1 of this example. A multilingual market research Web site apparatus 2 is installed in a company which performs a multilingual market research, and a multilingual user apparatus 3 is installed in the site of a company or person to be an object (answerer) of a multilingual market research. Further, a multilingual market research requester apparatus 4 is installed in the site of a company or person to request a multilingual market research.

Charges to be an object of net settlement include a charge for a multilingual market research which the multilingual market research requester apparatus 4 side has requested of the multilingual market research Web site apparatus 2 and a reward for an answer to the market research which the multilingual market research Web site apparatus 2 side has requested of a multilingual user apparatus 3. As such a reward for an answer, there are various kinds of rewards including a gift certificate and the like among countries, and is described in detail after this.

Further, in the configuration of FIG. 1, networks built in the respective countries (country A, country B and country C) are connected with one another through a gateway (GW) apparatus 6. A network built in each of the countries B and C has the same configuration as the configuration from the digital wire communication network 1 to the net-bank apparatus 5, and detailed illustration of it is omitted.

The digital wire communication network 1 is well known in composition and transmission method as ISDN, and is of a network configuration in which a digital exchange (PBX) is installed in a transmission circuit network.

In this example, a UNIX workstation is used as the multilingual market research Web site apparatus 2 in FIG. 1 and a general-purpose small computer is used by an answerer in a multilingual market research as the multilingual user apparatus 3. In ease that an answerer in a multilingual market research is a company or the like, a UNIX workstation system may be used. And as the net-bank apparatus 5 in FIG. 1, for example a UNIX workstation system is used and further, as the multilingual market research requester apparatus 4, a general-purpose small computer to be personally used is used. In case that a translation requester is a company or the like, for example a UNIX workstation system is used as the multilingual market research requester apparatus 4.

A general-purpose small computer to be used as the multilingual user apparatus 3 and the multilingual market research requester apparatus 4 is of a publicly known composition in hardware. That is to say, it is provided with an interface (I/F) circuit to be connected to a circuit connecting device (digital terminating device (DSU), terminal adaptor (TA) and the like) as well as a microprocessor (MPU) composed of a CPU, a ROM, a working RAM and the like. And this general-purpose small computer is provided with a reader/writer device which installs a communication protocol and a program for performing a market research using many languages or their translation and reads/writes process data by means of an information recording medium (floppy disk (FD), CD-ROM, detachable memory MS).

A market research using many languages or their translation according to the present invention is hereinafter abbreviated as a “multilingual market research of the present invention”.

Further, this general-purpose small computer is provided with a monitor device such as a color liquid crystal display (LCD) device and an input device consisting of a keyboard and a coordinates input device (mouse, input pad and the like), and is further provided with an input/output (I/O) circuit for performing a data input/output process to the respective portions. And this general-purpose small computer is provided with a memory for storing process data in it and particularly a hard disk device performing a file operation for performing a “multilingual market research of the present invention”, and is provided with an I/F circuit for performing connection with a printer and the like.

The UNIX workstation system of the multilingual market research Web site apparatus 2 or the net-bank apparatus 5 in FIG. 1 are publicly known in hardware composition.

This UNIX workstation system is provided with a circuit connecting device comprising a DSU, a router and the like, a Web server being a main computer for performing a basic communication process and a database. And this UNIX workstation system is generally provided with also an edition server (for an i-mode mobile telephone, for example) for reediting such distributed data as graphics, characters and the like adaptively to application.

And such a UNIX workstation is provided with an interface circuit for installing a firewall application into a Web server and connecting an electronic mail/image (FAX) server or a general-purpose small computer. Further, a configuration in which such a UNIX workstation is provided with a LAN server for performing a sequence, an FTP server for performing an FTP (File Transfer Protocol) file transfer, an interworking function (IWF) server for processing connection on the Internet or the like and a Web server dedicated to executing a firewall application for prevention of invasion, and the like is publicly known.

In addition to these configurations, the UNIX workstation is provided with a reader/writer device for installing a communication protocol and a program for performing a “multilingual market research of the present invention” through an information recording medium and reading/writing process data, and a multilingual market research processing database performing various kinds of file processes (data storage and retrieval/multilingual market research processing database engine using a relational system or network system) for performing a “multilingual market research of the present invention” and a DNS server used for a distributed name management system (DNS: Domain Name System).

And in addition to this configuration, the net-bank apparatus 5 is generally provided with an SSL server for performing an encryption communication protocol (SSL: Secure Sockets Layer) used in an encryption transmission for various kinds of security protection. Such a Web server under a TCP/IP environment is implemented as a multifunctional apparatus by using a computer and having a communication protocol and a program installed in it. And the Web server has the same composition as a general-purpose small computer, and may be changed in architecture adaptively to said “multilingual market research of the present invention”.

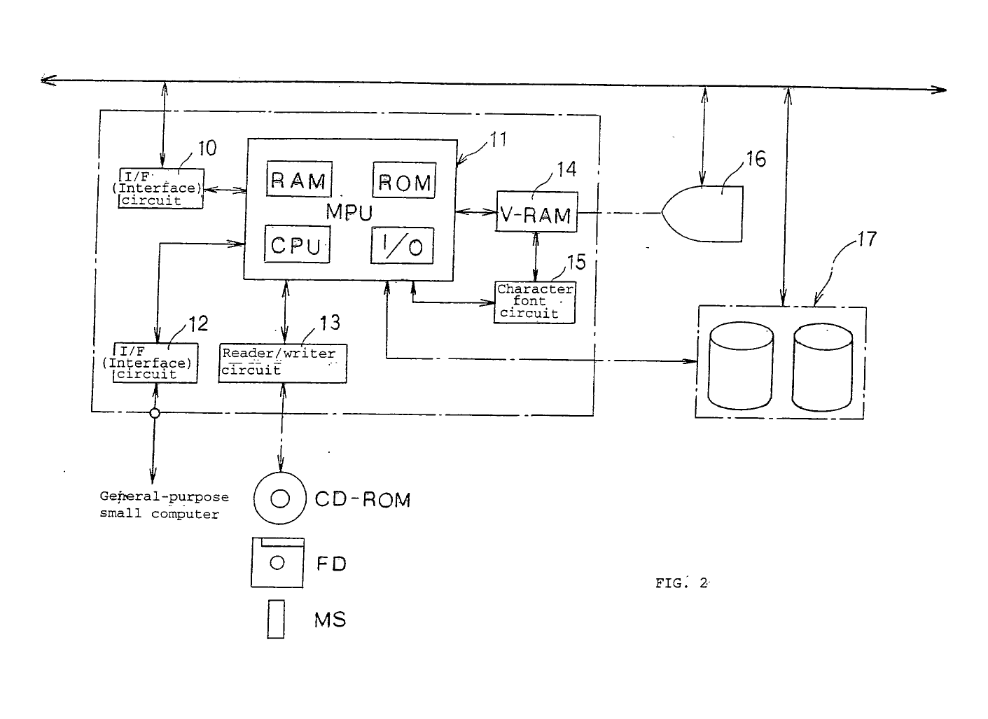

In this case it is enough to make its composition in consideration of traffic volume in processing a communication protocol and in consideration of the quantity of process data in data processing. For example, such a system may be composed in consideration of a duplexed CPU configuration, disposition of a plurality of multilingual market research databases, use of a mass storage and the like. FIG. 2 is a block diagram showing a composition example of a main part of a Web server for carrying out the present invention. This example is provided with an I/F circuit 10 which is connected to a bus of a UNIX workstation and performs an interface process with another apparatus not illustrated. And this example is provided with a microprocessor (MPU) 11 to be connected to the I/F circuit 10 and a bus. The microprocessor 11 is composed of a working RAM, a RAM having a boot control program stored in it, an input/output (I/O) circuit, a CPU and the like. The microprocessor 11 is provided with an I/F circuit 12 for connecting with a general-purpose small computer and a reader/writer device 13.

The reader/writer device 13 installs a communication protocol and a program for performing a “multilingual market research of the present invention” through an information recording medium (floppy disk (FD), CD-ROM or detachable memory MS) and reads/writes process data. And the microprocessor 11 is provided with a video RAM (V-RAM) 14 and a character font conversion circuit 15 for converting/generating the size of characters displayed for each language. This character font conversion circuit 15 is composed of a RAM and the like comprising a conversion table for converting each language character at a ratio of the smallest font. Output of the V-RAM 14 is transferred to a monitor device 16 connected to a bus of a multidrop mode. And the microprocessor 11 performs data processing for performing a “multilingual market research of the present invention” with a multilingual market research (MR) database (DB) apparatus 17 connected to the bus.

The multilingual market research database apparatus 17 can be also distributively disposed at a remote place using a router and the like.

Next, the process and operation of this embodiment are described in the following order.

(1) Application related to communication operation of each apparatus in FIG. 1

(2) Transmission form of the digital wire communication network 1 shown in FIG. 1

(3) Operation of each apparatus shown in FIG. 1

(4) Program in each apparatus shown in FIG. 1

(5) Multilingual translation network

(6) Process in a multilingual market research database

(7) Outline of performance of a “multilingual market research of the present invention”

(8) Details of a “multilingual market research of the present invention”

(8-1) Invitation of answerers to a market research

(8-2) Processing procedure of performance of a market research

(9) Another embodiment being in combination with a mobile communication network

(1) Application related to communication operation of each apparatus in FIG. 1

Each apparatus shown in FIG. 1 performs, as its communication protocol and program, a communication connecting process by means of TCP/IP, a language processing function (writing and speech processing, JPEG static image processing or MPEG dynamic image processing by means of data compression) by means of HTML (Hyper Text Markup Language), transfer by means of a hyperlink function, a two-way communication by means of HTTP (Hypertext Transfer Protocol), file transfer by FTP, and an external application by means of CGI (Common Gateway Interface). Each apparatus is equipped with a Web browser (application) for performing at electronic mail communication and extranet (Internet) surfing for this purpose.

In FIG. 1, each apparatus performs a file transfer by publicly known IP packets in two-way communication through a TCP/IP link. Such a transfer process on an extranet is performed by an object pointing operation in HTTP (object pointing (clicking) to a radio button, anchor, push button or the like by a coordinates input device such as a mouse or the like). In this case, an end description character (FIN) of opening of a TCP connection, an acknowledgement character (ACK) and the like are stored in a file format, and a the transfer is performed through identification of them.

(2) Transmission form of the digital wire communication network 1 shown in FIG. 1

The digital wire communication circuit network 1 shown in FIG. 1 transmits packets at transmission rates of 64 kbits/sec, 384 kbits/sec and 1.5 Mbits/sec, for example. At a transmission rate of 64 kbits/sec, it performs a “2B+D (information channels of 32 kbps X2+control channel of 16 kbps)” transmission through a packet switching procedure X.31 (1.430/1.431, Q.921/Q.931, X.25 Protocol) by ITU-T Recommendations. It is acceptable also to apply another high-speed transmission method (asymmetric digital transmission, for example) and to apply a high-speed communication method (gigabit high-speed data communication method, for example).

(3) Operation of each apparatus shown in FIG. 1

A general-purpose small computer for the multilingual user apparatus 3 and the multilingual market research requester apparatus 4 shown in FIG. 1 performs a well-known operation. Detailed description of it is omitted.

Further, a UNIX workstation for the multilingual market research Web site apparatus 2 and the net-bank apparatus 5 in FIG. 1 performs a sequence for performing a “multilingual market research of the present invention” through a Web server, a LAN server and the like.

(4) Program in each apparatus shown in FIG. 1

The general-purpose small computer or UNIX workstation performs a “multilingual market research of the present invention” by means of a communication protocol and a program executed by a CPU (including also a CPU of the Web server). These communication protocol and program are installed into each apparatus together with said general-purpose communication protocol and program in combination with a communication protocol and program specialized in performing a “multilingual market research of the present invention”.

Said “multilingual market research of the present invention” is provided as an information recording medium (FD, CD-ROM or detachable memory for example) having its program stored in it. In other words, it is offered as a general-purpose package capable of being on the market.

(5) Multilingual translation network In a two-way computer communication network shown in FIG. 1, a system of the present invention performs a “multilingual market research of the present invention” and functions also as a multilingual translation network performing translation in many languages through a communication network.

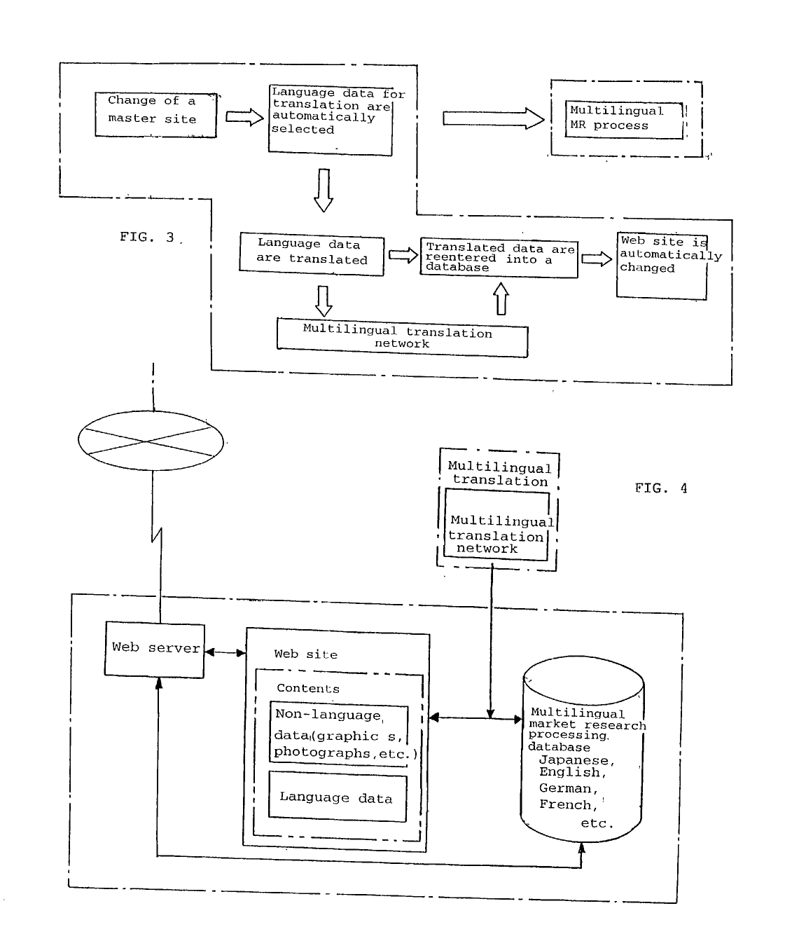

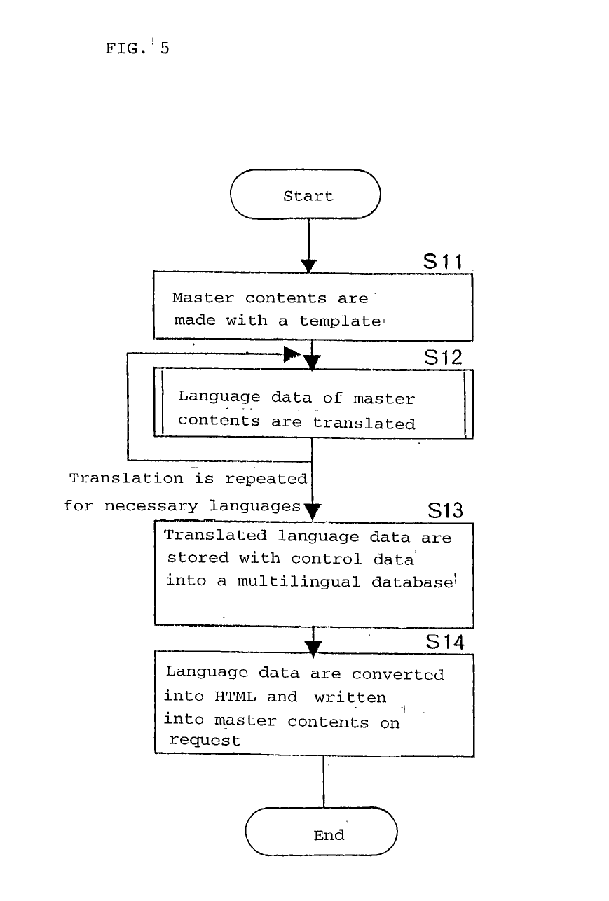

FIG. 3 is a diagram for explaining this multilingual translation and market research (market research/MR) process, and FIG. 4 is a block diagram for explaining a functional composition for performing the translation and market research of FIG. 3.

Referring to FIGS. 3 and 4, the multilingual translation and market research process comprises;

(a) a step of changing a master Web site on the basis of a multilingual translation,

(b) a step of automatically selecting language data for translation excluding non-language data (image data of graphics and photographs) from master contents of the master Web site,

(c) a step of translating language data through a “multilingual translation network” where translators performing translation in many languages are organized on an extranet, said translation being an automatic machine translation or a manual input translation,

(d) a step of reentering language data which have been translated and transferred through the “multilingual translation network” into a multilingual market research database apparatus 17, and

(e) a step of automatically changing the Web site.

Such a multilingual translation process utilizing the multilingual translation network is also used in a multilingual market research.

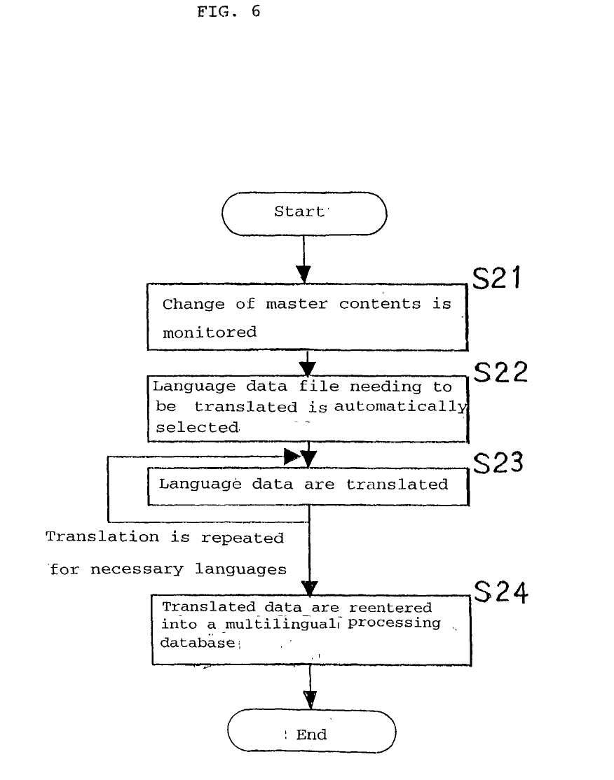

FIG. 5 is a flowchart showing a procedure of performing a multilingual translation utilizing a multilingual translation network, and FIG. 6 is a flowchart showing a procedure of performing maintenance of the multilingual translation.

In FIG. 5, for example, master contents are generated by means of a template (step S11). Next, language data in the master contents are translated (step S12). Routines for the processes in steps S21 and S22 are repeated for necessary languages. Next, the translated language data are stored together with control information into the multilingual market research database (step S13). Further, the language data are converted into HTML data and then are written into the master contents on request (step S14).

In FIG. 6, the change of the master contents is monitored (step S21). A language data file needing to be translated is automatically selected (step S22). The language data is translated (step S23). Routines for the processes in steps S21 to S23 are repeated for necessary languages. Next, the translated language data are reentered into the multilingual processing database (step S24).

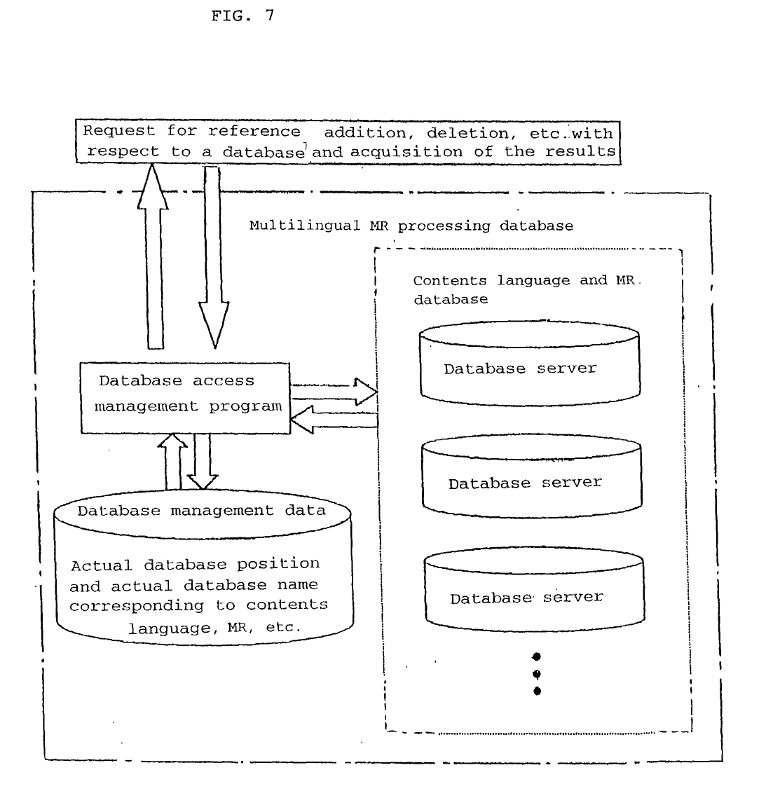

(6) Process in a multilingual market research database FIG. 7 is a block diagram for explaining a process in a multilingual market research processing database.

In FIG. 7, this multilingual market research processing database is used in a multilingual market research as well as a multilingual translation network described with reference to FIGS. 4, 5 and 6. This multilingual market research processing database performs its data processing by executing a database access management program. This access management program performs requests for reference, addition, update, deletion and the like of data with respect to the multilingual market research processing database and performs acquisition of their results.

And database management data are exchanged by executing the database access management program. These database management data are an actual multilingual market research processing database position and an actual multilingual market research processing database name corresponding to a contents language and the like. And data are exchanged with a contents language database by executing the database access management program. This contents language database is composed of a plurality of database servers. And in the multilingual market research processing database, the tracking (matching judgment) of the attribute information of an answerer (multilingual user apparatus 3) (the personal information of an answerer including its translatable language, area, name, address, sex and age) with market research contents is performed and answer data to a market research are stored.

Such a multilingual market research processing database is provided with a plurality of servers, which can be distributively disposed. An actual server name, server position, multilingual market research processing database name and the like are acquired from database management data in response to a request for a language ID, a page ID and the like, and a multilingual market research processing database desired out of database servers is accessed.

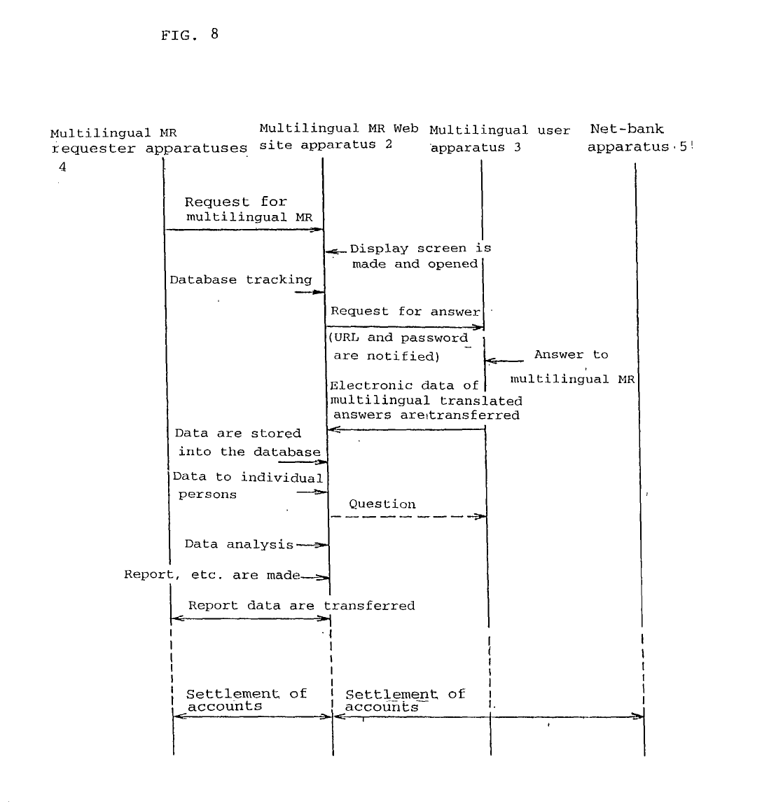

(7) Outline of performance of a “multilingual market research of the present invention” FIG. 8 is a sequence diagram showing an outline of a “multilingual market research of the present invention”.

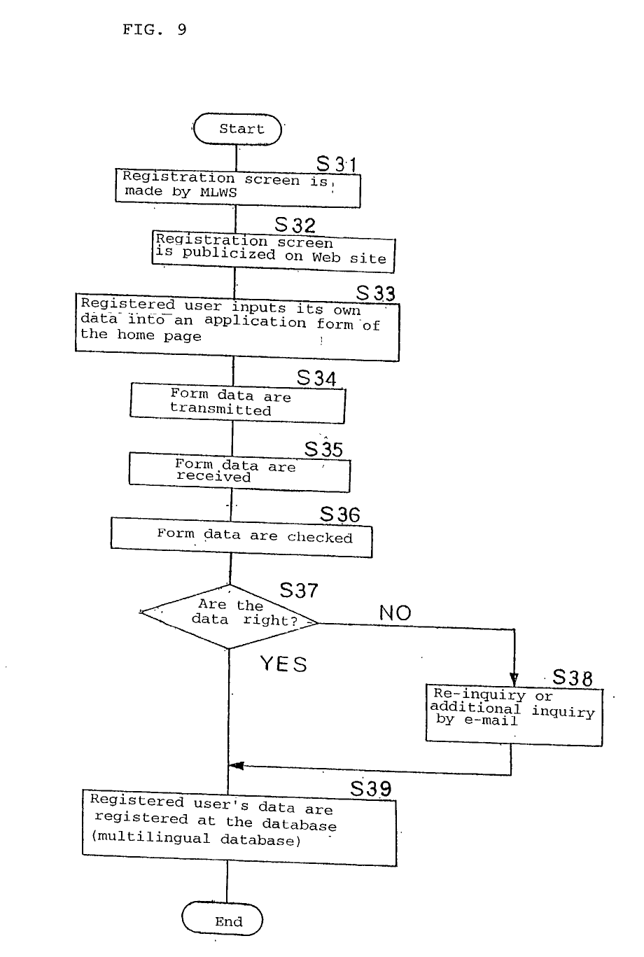

Referring to FIG. 8, this outline of a “multilingual market research of the present invention” corresponds to the following flowcharts of FIGS. 8 and 9. The multilingual market research Web site apparatus 2 takes in a request for translation from a multilingual market research requester apparatus 4 by way of an electronic mail or a Web site (home page) through a digital wire communication network 1. The language of this request is one language out of many languages (Japanese, for example).

Therefore, the multilingual market research Web site apparatus 2 is provided with a Web browser of application capable of reading many languages as a general-purpose Web browser. For example, an application for performing judgment by tracking (matching) with a language possible to be transferred in advance is installed. And like “cookie”, its language is judged by identifying that it is a former visitor to the home page. It is acceptable also to identify a navigation language or navigation browser language returned by the installed Web browser.

Next, the multilingual market research Web site apparatus 2 transfers a request for translation to a multilingual user apparatus 3 side being capable of translating a language specified by the request and answering to the market research. The multilingual user apparatus 3 side makes and transfers an answer to the specified market research to the multilingual market research Web site apparatus 2.

The multilingual market research Web site apparatus 2 stores the transferred answer data to the multilingual market research into the multilingual market research database apparatus 17 in FIG. 2. After this, it examines this database and, in case that a defect has been found by this examination, asks a question and replenishes additional data to complete a report. This report is transferred from the multilingual market research Web site apparatus 2 to the multilingual market research requester apparatus 4. After this, electronic settlement of accounts (transfer of fund) using a debit card and the like is performed among the multilingual user 3 side, the multilingual market research Web site apparatus 2 and the net-bank apparatus 5 according to need.

Various kinds of payment methods (bank transfer of fund, check payment and the like) using no net-bank apparatus 5 in particular may be applied to this settlement of accounts.

(8) Details of “multilingual market research of the present invention”

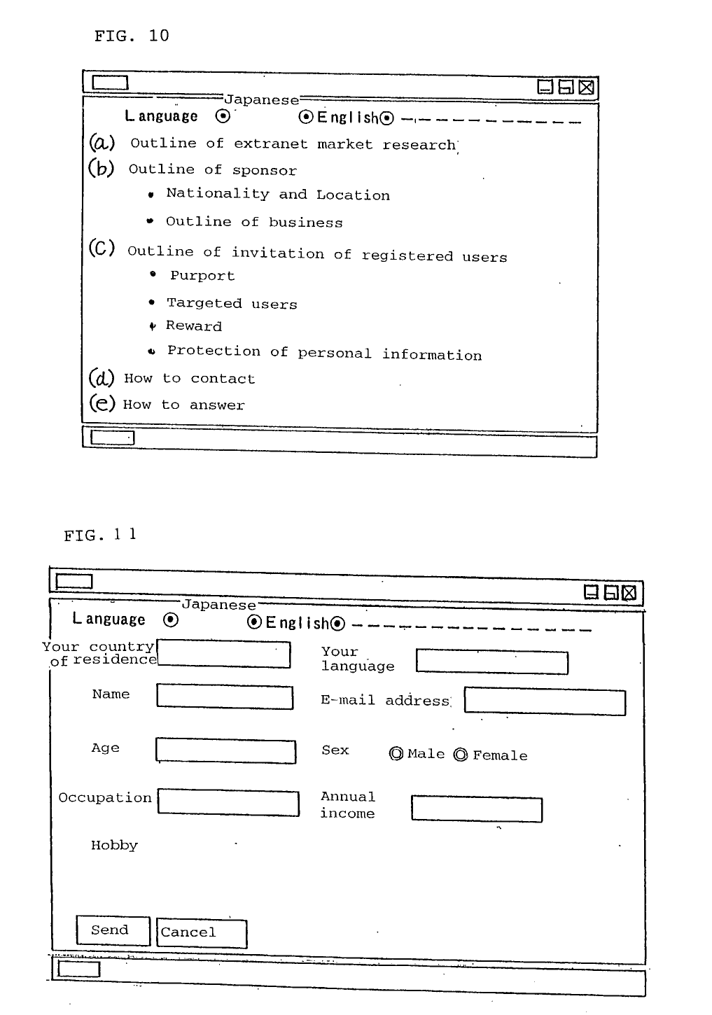

(8-1) Invitation of answerers to a market research FIG. 9 is a flowchart showing a processing procedure of invitation of answerers to a multilingual market research. And FIG. 10 shows a display screen for invitation of answerers to the multilingual market research, and FIG. 11 shows an input screen for applying for invitation of answerers to the multilingual market research.

In FIG. 9, in response to a request from a multilingual market research requester apparatus 4, an administrator of a multilingual market research Web site apparatus 2 prepares and opens a home page for inviting answerers to the market research by means of a multilingual service (see MLWS in FIG. 3) on the Web site (steps S31 and S32). A multilingual user apparatus 3 side (registered user) who has read this home page of the Web site inputs its own data into an application form of the home page and transmits (transfers) the inputted data by pointing (clicking) the object of transmission (steps S33 and S34).

The multilingual market research Web site apparatus 2 side takes in and examines the form data from the multilingual user apparatus 3 side through CGI and the administrator judges whether or not the data are adequate (steps S35, S36 and S37). In case that the form data from the multilingual user apparatus 3 side are inadequate (No in S37), the multilingual market research Web site apparatus 2 side asks again an additional question of the multilingual user apparatus 3 side by electronic mail and the multilingual user apparatus 3 side inputs and replenishes the additional information to the display screen (step S38).

After this replenishment by the additional question or when the multilingual market research Web site apparatus 2 side has judged the form data to be adequate (Yes in S37), the data of the multilingual user apparatus 3 side (registered user) are registered at the multilingual market research database apparatus 17 (step S39).

This registration at the database is the registration at a contents language database shown in FIG. 7 corresponding to a selected language in FIGS. 10 and 11.

Referring to FIG. 10, on this display screen of invitation, radio buttons (Japanese, English, and so forth) for selecting a language (Language) is displayed and the following items related to an outline of the market research on an extranet.

(a) Outline of the market research (explanation of an outline of the multilingual market research)

(b) Outline of the sponsor (an outline of the company performing the market research)

Nationality (explanation of the nation of the company performing this market research)

Location (explanation of the location of the company performing this market research)

Outline of business (explanation of an outline of the business of the company performing this market research)

(c) Outline of invitation of registered users (multilingual user apparatus 3 side)

Purport (explanation of the purport of the multilingual market research)

Targeted objects (explanation of what country (area) and what people are targeted by the market research)

Reward (explanation of a reward for cooperation with the market research) This reward is a reward for an answer (including translation), and points corresponding to the number of answered items or to the degree of difficulty in answer are given. Further, an article or a gift certificate is offered (sent) according to the points. The article and gift certificate are displayed in number and content on the display screen, and selection of them is performed by an answerer.

And the reward is settled by transfer of fund between companies. For example, a multinational restaurant chain or a multinational gasoline sales network is utilized.

Protection of personal information (explanation of prohibition of leakage of the personal (attribute) information of registered users)(d) How to contact (explanation of how to obtain and use the URL of a market research Web site and the password for reading and answering by electronic mail)

(e) How to answer (explanation of how to write to a home page of the market research Web site and how to transmit) Referring to FIG. 11, on this input screen of application, radio buttons (Japanese, English, and so forth) for selecting a language (Language) is displayed and the following items to input to the input screen are displayed.

There are displayed answerer's country of residence, language in daily use (including the possibility of translation into a requested language), name, electronic mail (e-mail) address, age, sex (to be selected), occupation, annual income and hobby as well as objects of transmission (transfer) and cancellation of the input screen.

(8-2) Processing procedure of performance of a market research

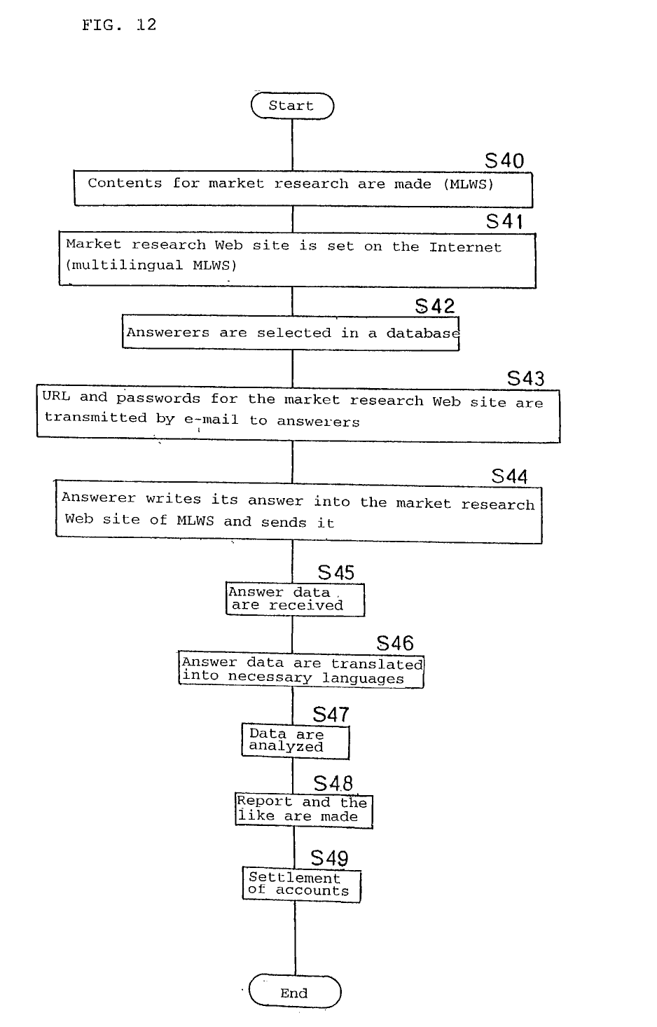

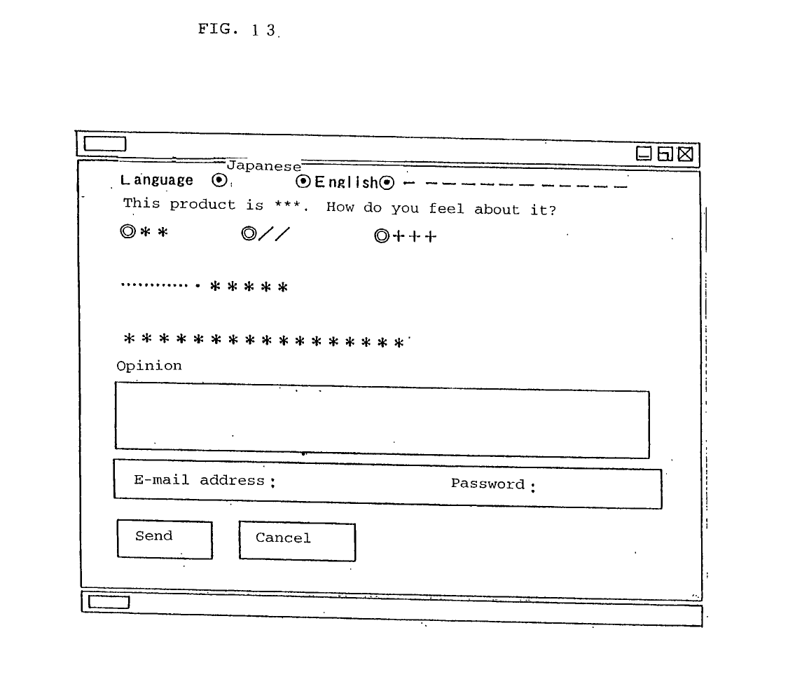

FIG. 12 is a flowchart showing a processing procedure of performing a multilingual market research, and FIG. 13 shows a display screen of a multilingual market research site. And FIG. 14 shows another display screen of a multilingual market research site.

Referring to FIG. 12, first, contents for the market research (to be installed in a home page of the Web site) are prepared in a necessary number of languages (see a multilingual service MLWS in FIG. 3) (step S40).

This Web site is installed into the multilingual market research Web site apparatus 2 (see a multilingual service MLWS in FIG. 3). That is to say, it is provided on the Internet (step S41). This Web site confidentially deals with a page needing to be confidential. For example, this is a case of performing a market research with respect to reaction to a new product in various countries (in many languages). Thus, an answerer is notified of the URL and password of a Web site in a language capable of being translated by the answerer, as described in the following (see FIG. 13).

Next, information retrieval is performed in the multilingual market research database apparatus 17 (see a multilingual market research processing database engine in FIGS. 3 and 4) of the multilingual market research Web site apparatus 2, and tracking (matching) of attribute information registered through the input screen of FIG. 11 with contents of the market research publicized on the Internet (matching judgment of information including a language to be an object of translation) is performed (step S42).

The URL of the market research Web site and the passwords corresponding to plural answerers (multilingual user apparatuses 3) obtained by this tracking (matching) are transmitted to these answerers by electronic mail (e-mail) (step S43).

An answerer (multilingual user apparatus 3) transmits the URL and opens the Web site, and then inputs its password and opens the home page of the market researchl of FIGS. 13 and 14. And the answerer transmits an answer to the market research, said answer being translated or not translated by the answerer, to the market research performer (multilingual market research Web site apparatus 2) (step S44, see FIG. 14). This destination of transmission may be the multilingual market research requester apparatus 4 being the requester side for this market research instead of the multilingual market research Web site apparatus 2.

The multilingual market research Web site apparatus 2 side receives and stores the answer from the answerer (multilingual user apparatus 3) into the multilingual market research database apparatus 17 (step S45).

Next, in case that the answer received from the answerer (multilingual user apparatus 3) has not been translated into a necessary language, the multilingual market research Web site apparatus 2 side performs translation onto the answer through the multilingual translation network by means of a translation process (working) in many languages shown in FIG. 3 (step S46).

Next, answer information stored in the multilingual market research database apparatus 17 of the multilingual market research Web site apparatus 2 are analyzed on the basis of a request from the requester side (multilingual market research requester apparatus 4) (step S47). A report is made by arranging the database analysis and transmitted from the multilingual market research Web site apparatus 2 to the multilingual market research requester apparatus 4 being the requester side. For example, it is transmitted by electronic mail (step S48). Alter this, settlement of accounts related to a request for the market research or a reward for an answer to the market research is performed through the net-bank apparatus 5, as described with reference to FIG. 8.

Referring to FIG. 13, this display screen of the market research site is used for asking an answerer to answer to the market research by means of a screen containing the URL and password. On this display screen, radio buttons (Japanese, English, and so forth) for selecting a language (Language) is displayed and the following items related to the market research are displayed. And this screen introduces a product and inquires the “feeling” to it. And it provides an opinion column for it. An answerer capable of translating writes its translated text in this opinion column.

And this screen displays the electronic mail (e-mail) address and password of the destination of transmission of an answer (multilingual market research Web site apparatus 2).

Referring to FIG. 14, this display screen of the market research site is used for performing, for example, a detailed market research of a product. The purport of the market research, product information and questionnaire items are displayed.

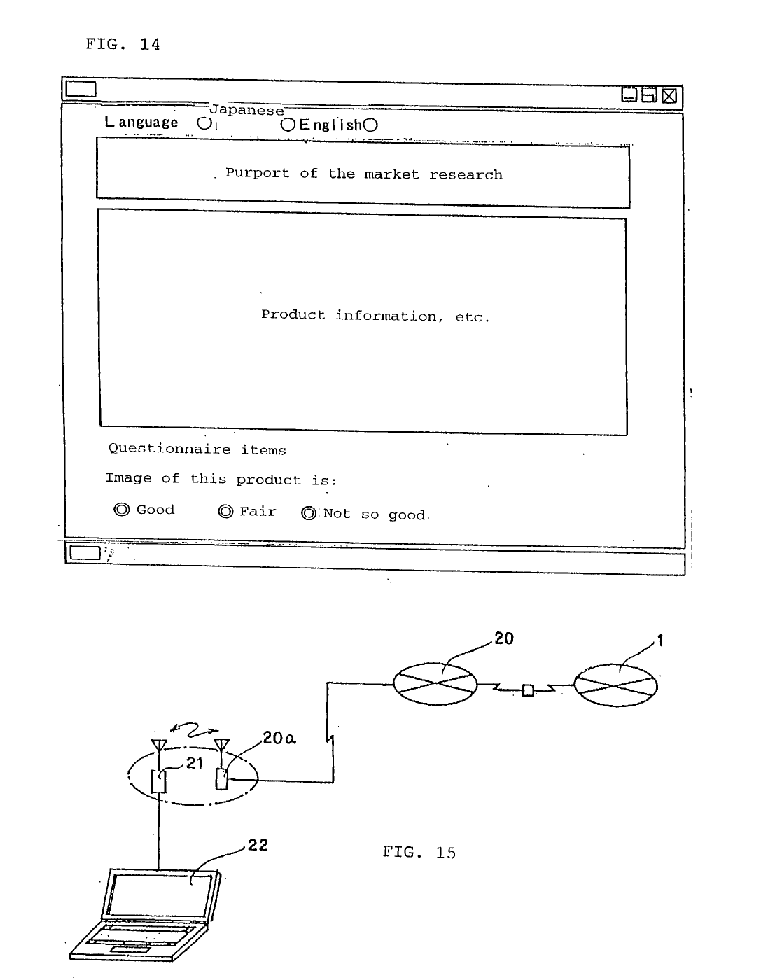

(9) Another embodiment being in combination with a mobile communication network FIG. 15 is a block diagram showing the configuration of a main part of a mobile communication network.

This example comprises a digital mobile communication circuit network 20 of a PDC (Personal Digital Cellar Telecommunication System) method, a PHS (Personal Handyphone System) method and the like connected by a connection device (gateway device or PHS connection device) for performing a communication protocol conversion and the like with the digital wire communication circuit network 1 shown in FIG. 1, and a mobile terminal 21 as a radio communication means to be connected with a cell base station 20a through a radio channel. The mobile terminal 21 has a mobile computer 22 connected to it.

This mobile terminal 21 is of an ordinary composition which comprises, for example, a transmitter/receiver part, modulator/demodulator part, time-division multiplexer part, Codec (coder/decoder) part, CPU, frequency change synthesizer, reception field strength (RSSI) detector part, external device connection interface part, incoming indicator light emitting diode, keypad, liquid crystal display device, incoming indication vibrator and the like. The mobile computer 22 is also of a similar composition to a general-purpose small computer of the multilingual user apparatus 3 and the like in FIG. 1.

A method of transmission between the digital mobile communication circuit network 20 and a mobile terminal 21 may be any of a TDMA (PDC) method, TDMA/TDD (PHS) method and CDMA method (IS-95/IMT-2000), and its modulation method (PSK method or the like) is not limited in particular.

The digital mobile communication circuit network 20 and a mobile terminal 21 communicate with each other through a digital mobile communication circuit network 3 by means of a radio section (air interface) of ARIB-27/28 standard (PDC method/PHS method), for example. It is preferable to apply the PHS method which can perform a broad-band transmission which is fast in data transfer rate in the present state and makes it easy to access the Internet by means of the PIAFS (PHS Internet Access Forum Standard) method to this communication.

These mobile terminal 21 and mobile computer 22 perform a “multilingual market research of the present invention” described above through the digital mobile communication circuit network 20. In this embodiment, a variation example as described in the following is also possible.

The digital wire communication circuit network 1 may use an analog telephone network PSTN (Public Switched Telephone Network), and as a circuit connection device in this case, an NCU (Network Control Unit) and a modulator and demodulator (modem) may be used.

And the present invention can be also implemented by using a digital wire communication circuit network 1 in combination with a computer-to-computer communication using a communication protocol such as Z/YMODEM and the like in place of the TCP/IP transmission method.

Further, in the configuration of FIG. 1, a multilingual market research covering various countries (areas), namely, a market research through an extranet has been explained, but a multilingual market research can be performed also in one country (area). That is to say, a multilingual market research can be performed by inviting answerers who can perform translation into many languages and have knowledge enough to cope with a market research in their country. In this case, the Internet in one country (area) is used.

And each apparatus of FIG. 1 may be formed into a duplex configuration composed of a current system and a spare system in consideration of improving its transmission reliability and preventing loss of stored data.

Additionally, the present invention is implemented by utilizing the publicity (utilization by many unspecified persons) on the Internet, but can be applied also to a closed communication network being not opened to the public such as a company's Ethernet LAN, WAN (Wide Area Network) having FDDI-LAN, and the like as it is. And these embodiments have been described under the assumption that a program is installed by means of an FD (floppy disk), CD-ROM or detachable memory, but such a program can be also installed by download through the Internet, for example.

The above application and variation examples can be easily carried out by persons in the same field, and the application and variation examples within the equal scope are all included in the present invention.

As apparently known from the above description, according to a method for performing multilingual market research by means of a two-way computer communication network of the present invention, and a communication system and information recording medium for the same method, it has been put into practice to ask answerers to a market research to answer to the market research in many languages and acquire answers to the market research adapted to each of multilingual areas and/or multilingual users.

As a result, an effect that it becomes possible to quickly and securely perform an international market research in many languages through a two-way computer communication network and, for example, quickly and securely perform an international market research based upon a request from a multinational corporation. In this case, there is an effect that the multinational corporation and the like can easily develop onto the market.

### INDUSTRIAL APPLICABILITY

The present invention can be applied to a method for performing multilingual market research through a two-way computer communication network, said method performing, for example, an international market research in many languages by utilizing a two-way computer communication network, and a communication system and information recording medium for the same method.

1. A method for performing a multilingual market research through a two-way computer communication network, comprising;
a step in which a market research performing side receives a request for a multilingual market research,
a step in which the market research performing side invites answerers to the multilingual market research through said communication network,
a step in which the market research performing side asks the answerers who have applied for the invitation to answer to the market research in many languages through said communication network,
a step of translating answer information to the multilingual market research through a multilingual translation network, and
a step in which the market research performing side performs a report based on answer information to the market research from the answerers to the market research requester side.

2. A method for performing a multilingual market research through a two-way computer communication network according to claim 1, wherein said multilingual market research is an international market research related to areas where many languages are in use and/or users of many languages.

3. A method for performing a multilingual market research through a two-way computer communication network according to claim 1, wherein said market research performing side obtains attribute information related to answerers including their translatable languages, areas, names, addresses, sexes and ages from the answerers when inviting answerers to said multilingual market research, and
selects contents of requested market research information, said contents being matched with the attribute information, and asks the answerers to answer to the market research.

4. A method for performing a multilingual market research through a two-way computer communication network according to claim 1, wherein an answerer performs translation through said multilingual translation network when the answerer answers to the market research.

5. A method for performing a multilingual market research through a two-way computer communication network according to claim 1, wherein the market research performing side receives answer information to the market research from an answerer through a communication network and thereafter a translator other than the answerer performs translation through said multilingual translation network.

6. A method for performing a multilingual market research through a two-way computer communication network according to claim 1, wherein said market research performing side and the market research requester side ire the same as each other.

7. A method for performing a multilingual market research through a two-way computer communication network according to claim 1, settling a reward to said answerer and a charge for said market research through the communication network.

8. A method for performing a multilingual market research through a two-way computer communication network according to claim 1, settling said reward to an answerer by offering an article including a gift certificate.

9. A method for performing a multilingual market research through a two-way computer communication network according to claim 1, wherein the market research performing side judges whether or not said answer information to the market research from an answerer is adequate and, in case that the answer information is inadequate, asks a question of the answerer to compensate for the inadequacies.

10. A method for performing a multilingual market research through a two-way computer communication network according to claim 1, wherein the market research performing side gives a password to each of answerers and the market research requester side and performs transmission/reception of information through the communication network by means of the passwords.

11. A multilingual market research communication system for performing a multilingual market research using a two-way computer communication network, comprising;
a multilingual market research Web site apparatus for receiving a request for a multilingual market research, performing invitation of answerers to the multilingual market research, asking an answerer who has applied for this invitation to answer to the multilingual market research and transferring a report based upon answer information to the market research from answerers to the market research requester side,
a multilingual user apparatus for responding to the invitation of answerers to the multilingual market research from said multilingual market research Web site apparatus and transferring answer information to the requested market research, and
a multilingual market research requester apparatus for requesting said multilingual market research Web site apparatus to perform a multilingual market research and receiving a report of the market research from said multilingual market research Web site apparatus.

12. A multilingual market research communication system according to claim 11, wherein said communication network is a communication network under a TCP/IP environment.

13. A multilingual market research communication system according to claim 11, wherein said communication network is a public or non-public wire communication network, and said multilingual market research Web site apparatus, multilingual user apparatus and multilingual market research requester apparatus each are a fixed computer.

14. A multilingual market research communication system according to claim 11, wherein said communication network is a public or non-public mobile communication network, and
said multilingual market research Web site apparatus, multilingual user apparatus and multilingual market research requester apparatus each are of a composition having a mobile telephone connected to a mobile computer or are a mobile telephone having a mobile computer function built in it.

15. A multilingual market research communication system according to claim 11, wherein a net-bank apparatus for settling a reward to be paid by said multilingual market research Web site apparatus side to a multilingual user apparatus side in compensation for an answer to the market research and a charge for the market research to be received by the multilingual market research Web site apparatus side from the multilingual market research requester apparatus side is further arranged on the communication network.

16. A multilingual market research communication system according to claim 11, wherein said multilingual market research Web site apparatus is provided with a multilingual market research database for, on request, matching (tracking) market research contents stored in it with attribute information related to answerers including their translatable languages, areas, names, addresses, sexes and ages obtained when inviting the answerers to a multilingual market research.

17. A multilingual market research communication system according to claim 11, wherein said multilingual market research Web site apparatus and said multilingual market research requester apparatus are separately arranged on the communication network, and said multilingual market research Web site apparatus and said multilingual market research requester apparatus are operated by different operators, or said multilingual market research Web site apparatus and said multilingual market research requester apparatus are formed in one and said multilingual market research Web site apparatus is operated by an operator of said multilingual market research requester apparatus.

18. A multilingual market research communication system according to claim 11, functioning as a multilingual translation network for performing multilingual translation using a communication network.

19. An information recording medium storing in it a program for enabling a substantial computer to control;
a process in which a market research performing side receives a request for a multilingual market research,
a process in which the market research performing side performs invitation of answerers to the multilingual market research through said communication network,
a process in which the market research performing side asks the answerers who have applied for the invitation to answer to the multilingual market research through said communication network,
a process of translating answer information to the multilingual market research through a multilingual translation network, and
a process in which the market research performing side performs a report based on answer information to the market research from answerers to the market research requester side.

20. An information recording medium according to claim 19, storing in it a program for enabling a substantial computer to control one process or some combined processes or all of the following processes (a) to (g);
(a) a process of performing a request for a market research and a report of a market research through a communication network,
(b) a process of selecting market research contents matched with attribute information obtained when inviting answerers to the multilingual market research and asking answerers to answer to the market research,
(c) a process in which an answerer performs translation when answering to the market research,
(d) a process in which the market research performing side receives answer information to the market research through a communication network and thereafter a translator other than the answerer translates the answer information through a multilingual translation network,
(e) a process of settling a reward to an answerer and a charge for the market research through a net bank on the communication network,
(f) a process of correcting and compensating for inadequate answer information to the market research from an answerer through a communication network, and
(g) a process of transmitting/receiving information through a communication network by means of passwords.
